(19) United States
(12) Patent Application Publication
(10) Pub. No.: US 2026/0067291 A1
(43) Pub. Date: Mar. 5, 2026

(54) MONITORING, DETECTING, AND REMEDIATING SECURITY ISSUES

(71) Applicant: Ziff Davis, Inc., New York, NY (US)

(72) Inventors: Paul Apostolescu, Leesburg, VA (US); John Melvin Antony, Chantilly, VA (US); Usman Choudhary, Centreville, VA (US); Anssi Tauriainen, Helsinki (FI)

(73) Assignee: Ziff Davis, Inc., New York, NY (US)

(21) Appl. No.: 18/816,292

(22) Filed: Aug. 27, 2024

(51) Int. Cl. H04L 9/40

(52) U.S. Cl. CPC H04L 63/1416

(57) ABSTRACT

The devices, systems, and methods described herein are directed to identifying, investigating, and remediating security issues related to network-connected devices. In some examples, a structure of a network and the nodes associated with the network are identified, based at least partially on signals received from the nodes. Based on security-relevant information collected from the nodes, a potential security issue of a first node is identified. A second node of the network is queried regarding whether the second node has connected to the first node. A security analysis is performed on the second node based on results of the query.

### FIELD

The subject matter described herein relates to identifying security issues regarding network-connected devices.

### BACKGROUND

Information security is the practice of protecting information by mitigating information risks by preventing or reducing the probability of unauthorized or inappropriate access to data or information. Information security also involves actions intended to reduce the adverse impacts of such unauthorized or inappropriate access. Information security's primary focus is the balanced protection of data confidentiality, integrity, and availability without hampering the authorized and appropriate use of the data or information.

### SUMMARY

The devices, systems, and methods described herein are directed to identifying, investigating, and remediating security issues related to network-connected devices. In some examples, a structure of a network and the nodes associated with the network are identified, based at least partially on signals received from the nodes. Based on security-relevant information collected from the nodes, a potential security issue of a first node is identified. A second node of the network is queried regarding whether the second node has connected to the first node. A security analysis is performed on the second node based on results of the query.

### BRIEF DESCRIPTION OF THE DRAWINGS

FIG. 1 is a block diagram of a first example of a system for identifying security issues in a network. The system includes a measurement device and a computing device to perform a security analysis.

FIG. 2 is a block diagram of an example of the measurement device shown in FIG. 1.

FIG. 3 is a block diagram of a second example of a system for identifying security issues in a network in which the measurement device is integrated into the computing device.

FIG. 4 is a flow chart of an example of a method for identifying security issues.

### DETAILED DESCRIPTION

Since networks are very widely deployed in different environments, one of the most important use cases is the prevention, detection, and remediation of security threats to the existing networks. The devices, systems, and methods described herein are directed to identifying, investigating, and remediating security issues related to network-connected devices. Although some of the following examples may be described within the context of securing wireless networks generally, or Wi-Fi networks more specifically, the devices, systems, and methods described herein may be applied to any suitable network.

Although the different examples of devices, systems, and methods may be described herein separately, any of the features of any of the examples may be added to, omitted from, or combined with any other example. Similarly, any of the features of any of the examples may be performed in parallel or performed in a different manner/order than that described or shown herein.

As used herein, a “node of a network” can be used to describe any device that is capable of sending data to or receiving data from other nodes of the network. In some examples, a “node” may be an end device, also referred to herein as a client device, that serves as a source point or a destination point in the communication that occurs on the network. Examples of an end device include a laptop or desktop computer, a work station, a tablet, a mobile phone, a printer, a scanner, or a server, etc. In other examples, a “node” may be an intermediary device that is designed to forward data between other devices in the network. Examples of an intermediary device include wireless access points, routers, or repeaters, etc.

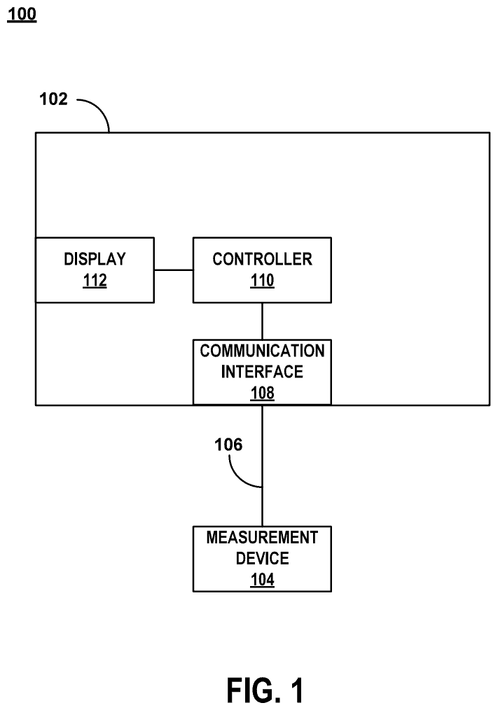

FIG. 1 is a block diagram of a first example of a system for identifying security issues in a network. The system includes a measurement device and a computing device to perform a security analysis. In the example shown in FIG. 1, system 100 includes local computing device 102 and measurement device 104. In some examples, local computing device 102 can be any on-site computing device that can receive and process data associated with a network. For example, local computing device 102 could be a tablet computer, a laptop computer, a smartphone, or a desktop computer. In other examples, any other suitable computing device, even a remote, off-site computing device, could be used to perform the functions described herein.

Local computing device 102 includes communication interface 108, controller 110, and display 112. In operation, local computing device 102 receives data from measurement device 104 via communication link 106. Communication interface 108 enables communication between measurement device 104 and local computing device 102. In the example shown in FIG. 1, communication link 106 is a wired communication link that operates in accordance with at least one of the family of Universal Serial Bus (USB) specifications. In other examples, communication link 106 may operate in accordance with other wired specifications. In further examples, communication link 106 may operate in accordance with any suitable wireless specification (e.g., Bluetooth).

Controller 110 includes any combination of hardware, software, and/or firmware for executing the functions described herein. An example of a suitable controller 110 includes software code running on a microprocessor or processor arrangement connected to memory (not explicitly shown).

Display 112 is used to display, to a user, information pertaining to a security analysis performed by controller 110. In this manner, the user can easily see the results of the security analysis, which may include potential security issues and actual security issues identified by controller 110. In some examples, display 112 includes an associated input mechanism (e.g., touchscreen, keyboard, microphone, etc.) by which the user can select one or more actions to remediate one or more of the identified security issues.

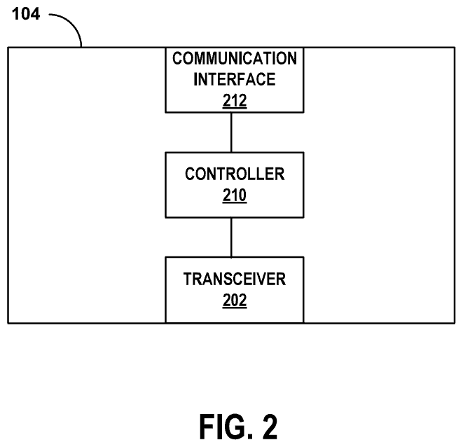

FIG. 2 is a block diagram of an example of measurement device 104 shown in FIG. 1. In the example shown in FIG. 2, measurement device 104 utilizes transceiver 202 to receive signals from and transmit signals to nodes associated with a network. In other examples, a separate transmitter and receiver may be utilized by measurement device 104.

In further examples, multiple receivers may be utilized by measurement device 104, each receiver being capable of scanning and monitoring a set of Wi-Fi channels and capturing all Wi-Fi link layer frames (e.g., packets) being heard on those channels. In still further examples, a single Wi-Fi radio (e.g., receiver or transceiver), module, or chipset can be configured to operate on the separate channels at the same time, which is referred to as a Dual Band Simultaneous (DBS) configuration. Thus, in some examples, the functionality of the measurement device, as described herein, may be accomplished with a measurement device having multiple receivers or a single, properly configured receiver (or transceiver).

The measurement device 104 shown in FIG. 2 also includes controller 210, which processes the signals received by transceiver 202. Controller 210 includes any combination of hardware, software, and/or firmware for executing the functions described herein. An example of a suitable controller 210 includes software code running on a microprocessor or processor arrangement connected to memory (not explicitly shown). It is worth noting that, in some examples, any of the functions described herein as being performed by controller 110 may be performed by controller 210, and vice versa.

Measurement device 104, as shown in FIG. 2, also includes communication interface 212, which measurement device 104 uses to communicate with local computing device 102 via communication link 106. In some examples, the communication between measurement device 104 and local computing device 102 includes providing data to local computing device 102 and receiving command instructions regarding which node or nodes of a network are selected for security analysis. As will be discussed more fully below, based on which node or nodes are selected for security analysis, controller 210 can dynamically configure transceiver 202 to monitor particular channels during the security analysis, in some examples.

In further examples, measurement device 104 may be any fixed, mobile, or portable equipment that performs the functions described herein. The various functions and operations described with reference to measurement device 104 may be implemented in any number of devices, circuits, or elements. Two or more of the functions of the measurement device may be integrated in a single device, and the functions described as performed in any single measurement device may be implemented over several measurement devices. In the interest of brevity, FIG. 1 only depicts one measurement device 104. However, any number of measurement devices may be utilized to receive signals, in other examples.

In operation, after measurement device 104 receives signals from one or more nodes of the network, measurement device 104 provides data pertaining to the received signals to local computing device 102 via communication link 106, in some examples. In further examples, the data pertaining to the received signals includes forwarding the received signals themselves. In other examples, the data pertaining to the received signals may include measurement values, signal characteristic values, or the like, as determined by controller 210 of measurement device 104. In some examples, controller 110 of local computing device 102 identifies a structure of the wireless network and the nodes associated with the network, based at least partially on the signals received from the nodes and/or on the data pertaining to the received signals, which was provided by measurement device 104.

In other examples, controller 110 may perform additional tasks associated with monitoring the network. In some of these examples, controller 110 may record snapshots of the data pertaining to the received signals at different times and compare changes between the snapshots of the data over time. Based on these comparisons, controller 110 can detect changes to the structure of the network, changes in which nodes are connected to and/or associated with the network, and anomalies that may represent a potential security threat. In other examples, controller 110 may also collect ongoing active Internet Protocol (IP) level connections, decode protocol relevant information, and provide security relevant visibility. For example, controller 110 may extract remote IP addresses and their geolocation, extract Domain Name System (DNS) and Server Name Indication (SNI) payloads, and extract Transport Layer Security (TLS) certificates. In other examples, controller 110 can simulate an active network and monitor and collect information regarding the behavior of external devices trying to connect to the simulated network.

Once controller 110 has identified the structure of the network and the nodes of the network, controller 110 can send control signals instructing measurement device 104 to collect security-relevant information from the identified nodes, in some examples. In further examples, the security-relevant information includes one or more of the following: IP address information, geolocation information, DNS information, SNI information, and TLS certificate information.

Based on the security-relevant information provided to local computing device 102 by measurement device 104, controller 110 identifies one or more potential security issues of a first node associated with the network, in some examples. In further examples, the potential security issue may include one or more of the following: a rogue node; a node with a vulnerable configuration; a node that is unpatched, has no encryption, or has substandard encryption; a substandard Wired Equivalent Privacy (WEP) connection; a substandard Wi-Fi Protected Access (WPA) connection; and a substandard Wi-Fi Protected Setup (WPS) connection. In other examples, controller 110 identifies the potential security issues by applying Intrusion Detection System (IDS) rules to the security-relevant information. In still further examples, controller 110 identifies an attacker associated with the potential security issue and collects information about one or more of the following: the attacker, a target of the potential security issue, and a type of attack associated with the potential security issue.

In other examples, controller 110 sends control signals instructing measurement device 104 to query a second node associated with the network regarding whether the second node has connected to the first node, and measurement device 104 would provide the results of the query to controller 110. Based on the results of the query, controller 110 may perform a security analysis on the second node, in some examples. For example, if the results of the query indicate that the second node had connected to the first node, controller 110 determines that a security analysis should be performed on the second node, but if the results of the query indicate that the second node had not connected to the first node, controller 110 determines that a security analysis should not be performed on the second node, in some examples. In further examples, controller 110 confirms, based on the results of the query and the results of the security analysis of the second node, whether the potential security issue of the first node is an actual security issue.

Although the foregoing example only describes querying the second node associated with the network regarding whether the second node has connected to the first node, controller 110 may send control signals instructing measurement device 104 to query a plurality of nodes associated with the network regarding whether one or more of the plurality of nodes has connected to the first node, in other examples. In further examples, upon the determination that one or more of the plurality of nodes has connected to the first node, controller 110 may send additional control signals instructing measurement device 104 to query one or more additional nodes regarding whether any of the additional nodes have connected with one or more of the plurality of nodes that had connected to the first node.

In some examples, controller 110 may also, upon detection of a potential security issue and/or upon confirmation of a security issue, alert a user (e.g., via display 112) of a potential security issue or malicious activity pattern in the data collected at the IP level, using rules, signatures, or machine-generated classifiers. For example, some of the criteria that may trigger controller 110 to alert a user include: devices connecting to countries of interest; connections using known, bad TLS certificates; reconnaissance activity (e.g., network wide scans, service detection attempts, etc.); data exfiltration (e.g., high volume of outbound data to server X from device Y using protocol Z); and beacon signal detection (e.g., referred to as a “regular heartbeat”). Of course, any other suitable criteria may also be used to trigger an alert to a user, in further examples.

In some examples, controller 110 remediates the potential security issue. For example, controller 110 may remediate the potential security issue by performing one or more of the following: remotely disconnecting vulnerable nodes, remotely securing vulnerable nodes, remotely terminating vulnerable connections, remotely configuring routers to blacklist devices associated with the attacker, and providing malicious or incorrect information to the attacker. In some examples, an open or weakly configured node may be shutdown or disconnected using a software-defined networking (SDN) controller or a manufacturer provided Application Programming Interface (API). In some examples, weak or open access points may be secured by changing credentials and/or their configuration. In some examples, malicious connections may be terminated using a Transmission Control Protocol (TCP) reset injection. In some examples, configuring a router to blacklist a device may be based on the Media Access Control (MAC) address of the device being blacklisted.

In some examples, controller 110 can automatically remediate potential and/or confirmed security issues. In other examples, controller 110 informs a user of the potential or confirmed security issues and awaits instruction from the user (e.g., via an input mechanism associated with local computing device 102) regarding what actions to take, if any, regarding remediation.

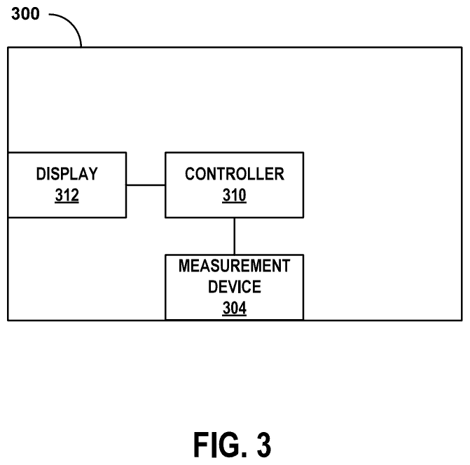

FIG. 3 is a block diagram of a second example of a system for identifying security issues in a network in which the measurement device is integrated into the computing device. In the example shown in FIG. 3, system 300 includes measurement device 304, controller 310, and display 312. In the example shown in FIG. 3, controller 310 is capable of performing the combined functions of controller 110 and controller 210, as described in connection with FIGS. 1 and 2. Thus, system 300 performs the combined functions of measurement device 104 and local computing device 102, as described herein.

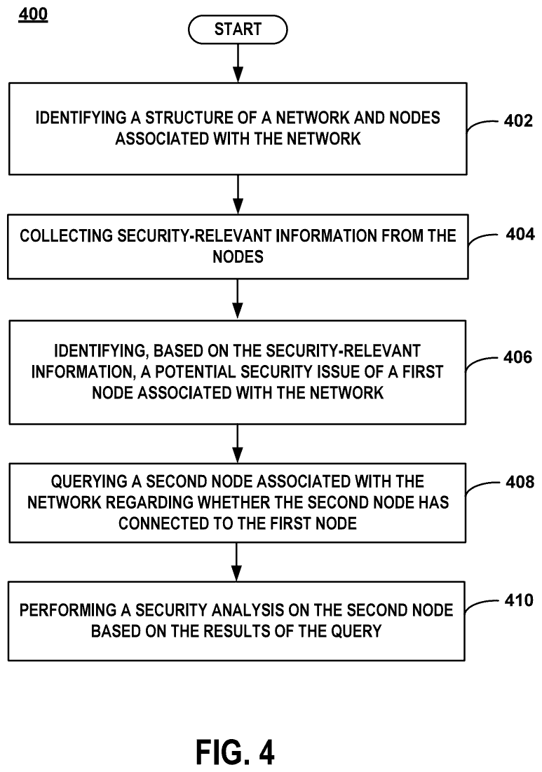

FIG. 4 is a flow chart of an example of a method for identifying security issues. The method 400 begins at step 402 with identifying a structure of a network and nodes associated with the network. At step 404, security-relevant information is collected from the nodes. At step 406, method 400 continues with identifying, based on the security-relevant information, a potential security issue of a first node associated with the network. At step 408, a second node associated with the network is queried regarding whether the second node has connected to the first node. At step 410, a security analysis is performed on the second node based on results of the query.

In other examples, one or more of the steps of method 400 may be omitted, combined, performed in parallel, or performed in a different order than that described herein or shown in FIG. 4. In still further examples, additional steps may be added to method 400 that are not explicitly described in connection with the example shown in FIG. 4.

In other examples, additional steps may be added to method 400 that are not explicitly described in connection with the example shown in FIG. 4. For example, in some examples, the method also includes confirming, based on the results of the query and the results of the security analysis of the second node, that the potential security issue of the first node is an actual security issue. In other examples, the method additionally includes (1) identifying an attacker associated with the potential security issue, and (2) collecting information about one or more of the following: the attacker, a target of the potential security issue, and a type of attack associated with the potential security issue. In further examples, the method also includes remediating the potential security issue. In these examples, remediating the potential security issue may include one or more of the following: remotely disconnecting vulnerable nodes, remotely securing vulnerable nodes, remotely terminating vulnerable connections, remotely configuring routers to blacklist devices associated with the attacker, and providing malicious or incorrect information to the attacker.

The foregoing devices, systems, and methods can operate in at least three different modes. For example, in a passive mode, the system can passively observe the network traffic (and Wi-Fi traffic, if applicable) to collect information of interest. In an active mode, the system can actively probe, connect to, and analyze visible nodes. In a decoy (deception) mode, the system can simulate artificial networks and devices to entice, trap, and investigate potential attackers.

Moreover, the foregoing examples can be deployed in at least three different manners. In some examples, a portable handheld device can be carried around a physical area of interest by a user. In other examples, a connected hardware device can be deployed or installed on the premises on which the wireless network operates. In further examples, a software agent can be installed on a computing device operated by a user. In still further examples, various combinations of these examples may be utilized.

Clearly, other examples and modifications of the foregoing will occur readily to those of ordinary skill in the art in view of these teachings. The above description is illustrative and not restrictive. The examples described herein are only to be limited by the following claims, which include all such examples and modifications when viewed in conjunction with the above specification and accompanying drawings. The scope of the foregoing should, therefore, be determined not with reference to the above description alone, but instead should be determined with reference to the appended claims along with their full scope of equivalents.

What is claimed is:

1. A method for identifying security issues, the method comprising:
identifying a structure of a network and nodes associated with the network;
collecting security-relevant information from the nodes;
identifying, based on the security-relevant information, a potential security issue of a first node associated with the network;
querying a second node associated with the network regarding whether the second node has connected to the first node; and
performing a security analysis on the second node based on results of the query.

2. The method of claim 1, wherein the security-relevant information includes one or more of the following: Internet Protocol (IP) address information, geolocation information, Domain Name System (DNS) information, Server Name Indication (SNI) information, and Transport Layer Security (TLS) certificate information.

3. The method of claim 2, wherein identifying the potential security issue includes applying Intrusion Detection System (IDS) rules to the security-relevant information.

4. The method of claim 1, wherein the potential security issue includes one or more of the following: a rogue node; a node with a vulnerable configuration; a node that is unpatched, has no encryption, or has substandard encryption; a substandard Wired Equivalent Privacy (WEP) connection; a substandard Wi-Fi Protected Access (WPA) connection; and a substandard Wi-Fi Protected Setup (WPS) connection.

5. The method of claim 1, further comprising:
confirming, based on the results of the query and the results of the security analysis of the second node, that the potential security issue of the first node is an actual security issue.

6. The method of claim 1, further comprising:
identifying an attacker associated with the potential security issue; and
collecting information about one or more of the following: the attacker, a target of the potential security issue, and a type of attack associated with the potential security issue.

7. The method of claim 1, further comprising:
remediating the potential security issue.

8. The method of claim 7, wherein remediating the potential security issue includes one or more of the following: remotely disconnecting vulnerable nodes, remotely securing vulnerable nodes, remotely terminating vulnerable connections, remotely configuring routers to blacklist devices associated with the attacker, and providing malicious or incorrect information to the attacker.

9. A system for identifying security issues, the system comprising:
a transceiver to receive signals from and transmit signals to nodes associated with a network; and
a controller to:
identify a structure of the network and the nodes associated with the network, based at least partially on the signals received from the nodes,
collect security-relevant information from the nodes,
identify, based on the security-relevant information, a potential security issue of a first node associated with the network,
query a second node associated with the network regarding whether the second node has connected to the first node, and
perform a security analysis on the second node based on results of the query.

10. The system of claim 9, wherein the security-relevant information includes one or more of the following: Internet Protocol (IP) address information, geolocation information, Domain Name System (DNS) information, Server Name Indication (SNI) information, and Transport Layer Security (TLS) certificate information.

11. The system of claim 10, wherein the controller identifies the potential security issue by applying Intrusion Detection System (IDS) rules to the security-relevant information.

12. The system of claim 9, wherein the potential security issue includes one or more of the following: a rogue node; a node with a vulnerable configuration; a node that is unpatched, has no encryption, or has substandard encryption; a substandard Wired Equivalent Privacy (WEP) connection; a substandard Wi-Fi Protected Access (WPA) connection; and a substandard Wi-Fi Protected Setup (WPS) connection.

13. The system of claim 9, wherein the controller further:
confirms, based on the results of the query and the results of the security analysis of the second node, that the potential security issue of the first node is an actual security issue.

14. The system of claim 9, wherein the controller further:
identifies an attacker associated with the potential security issue; and
collects information about one or more of the following: the attacker, a target of the potential security issue, and a type of attack associated with the potential security issue.

15. The system of claim 9, wherein the controller further:
remediates the potential security issue.

16. The system of claim 15, wherein remediating the potential security issue includes one or more of the following: remotely disconnecting vulnerable nodes, remotely securing vulnerable nodes, remotely terminating vulnerable connections, remotely configuring routers to blacklist devices associated with the attacker, and providing malicious or incorrect information to the attacker.

17. The system of claim 9, wherein the controller further:
determines a baseline communication pattern of the network; and
identifies one or more nodes that have a communication pattern that deviates from the baseline communication pattern.

18. The system of claim 9, wherein the controller further:
determines a baseline communication pattern of one or more other networks that have structures similar to the structure of the network; and
identify one or more differences between the baseline communication pattern of the one or more other networks and a communication pattern of the network.

19. The system of claim 9, wherein the controller further:
builds one or more communication profiles;
assigns one of the communication profiles to a particular node, based at least partially on recent activity of the particular node.

20. The system of claim 19, wherein the controller further alerts the particular node that a different communication profile is being assigned to the particular node.
